(19) United States
(12) Patent Application Publication
(10) Pub. No.: US 2015/0060199 A1
(43) Pub. Date: Mar. 5, 2015

(54) ORDER PICKERS

(71) Applicant: TRANSLIFT BENDI LIMITED, Worcestershire (GB)

(72) Inventors: Paul David Overfield, Worcestershire (GB); Simon Mark Brown, Worcestershire (GB)

(21) Appl. No.: 14/384,799

(22) PCT Filed: Mar. 8, 2013
(86) PCT No.: PCT/GB2013/000099

§ 371 Date: Sep. 12, 2014

(30) Foreign Application Priority Data
Mar. 12, 2012 (GB) 1204387.3

(51) Int. Cl. B66F 11/04; B66F 9/075; B66F 9/10

(52) U.S. Cl. CPC B66F 11/04; B66F 9/105; B66F 9/0759
USPC 182/69.4

(57) ABSTRACT

An order picker has a body section with a pair of ground engaging wheels and a first lift mechanism pivotally mounted to one end of the body section about a vertical pivot and one or more ground engaging wheels is/are provided on the first lift mechanism. A mechanism is provided for pivoting the first lift mechanism relative to the body section whereby the order picker may be steered. An open cab is provided on the body section whereby an operative may have access to stacks on either side of the order picker. The cab is mounted to the body section on a second lift mechanism by which the cab may be raised and lowered with respect to the body section independently of the first lift mechanism. A receptacle onto or into which picked items may be placed, the receptacle is mounted on the cab on the end thereof remote from the end of the body section to which the first lift mechanism is mounted.

This application is a National Stage completion of PCT/GB2013/000099 filed Mar. 8, 2013, which claims priority from British patent application serial no. 1204387.3 filed Mar. 12, 2012.

### FIELD OF THE INVENTION

The present invention relates to improvements in and relating to Order Pickers.

### BACKGROUND OF THE INVENTION

Order Pickers are industrial trucks that are used to select items which are located in stacks. Conventionally an order picker includes a cab for an operative and a pallet into which the selected items may be placed. The Order picker is driven down an aisle between two stacks, so that the operative may pick items from pallets or storage bins located in the stacks on either side of the aisle.

Means may be arranged for elevating the cab, so that items may be selected from pallets or bins on upto three levels. The pallet would normally rise with the cab but may also be mounted on forks for vertical movement independently of the cab. This will enable the pallet to be lowered, as items are stacked upon it. The use of independently moveable forks will also allow the pallet to be removed from the Order Picker when the order has been filled.

With known Order Pickers, generally the maximum to which the cab may be elevated would typically be upto three levels, say 2.8 m to 4 m. Typically stacks may extend to 7 m to 12 m. It is common practice in warehouses to store reserve items on pallets or in bins above the pallets or bins from which the items are picked. If a conventional Order Picker comes to an empty pallet or bin, then it is necessary to call on a high reach lift truck to replace the empty pallet or bin with a replacement pallet or bin located at a bulk stock location to which the Order Picker is capable of reaching.

### SUMMARY OF THE INVENTION

The present invention provides an improved Order Picker which is capable of retrieving storage bins above the normal order picking levels.

According to one aspect of the present invention an Order Picker comprises a body section having a pair of ground engaging wheels and a first lift mechanism pivotally mounted to one end of the body section about a vertical pivot, one or more ground engaging wheels being provided on the first lift mechanism, means being provided for pivoting the first lift mechanism relative to the body section whereby the order picker may be steered, an open cab being provided on the body section whereby an operative located in the cab may have access to stacks on either side of the order picker, the cab being mounted to the body section on a second lift mechanism by which the cab may be raised and lowered with respect to the body section independently of the first lift mechanism; and a receptacle onto or into which picked items may be placed, the receptacle being mounted on the cab on the end thereof remote from the end of the body section to which the first lift mechanism is mounted.

With the order picker of the present invention, the first lift mechanism may be used to lift pallets or storage bins which are outside the range of the cab when elevated to its maximum height. A further advantage of the present invention is that the first lift mechanism may be used to lower a pallet or storage bin to a level at which it is accessible from the raised cab thus avoiding the need to lower the pallet or storage bin to ground level or first clear a space at a level which is accessible from the raised cab.

According to a preferred embodiment of the present invention, the first lift mechanism is capable of operating to heights of from 7 to 12 meters, while the second lift mechanism is capable of raising the cab to from 2.8 to 4 meters.

For safety considerations, the control means for, driving the order picker, pivoting the first lift mechanism relative to the body section and raising and lowering the first lift mechanism are preferably only accessible from the lowered position of the cab.

According to a further preferred embodiment of the invention, the receptacle is mounted with respect to the cab on a third lift mechanism, by which the receptacle may be raised and lowered with respect to the cab, to adjust the height of the receptacle as items are stacked onto or into the receptacle and to allow the receptacle to be deposited on to the ground when an order has been filled. The receptacle may, for example, be a pallet or bin.

### BRIEF DESCRIPTION OF THE DRAWINGS

The invention is now described, by way of example only, with reference to the accompanying drawings, in which:

FIG. 1 shows a perspective view of an order picker in accordance with the present invention;

FIG. 2 shows the order picker illustrated in FIG. 1 in conventional order picker raised mode;

FIG. 3 shows the order picker illustrated in FIG. 1 being used to access pallets stored above the level normally accessible to order picker in order picker mode;

FIG. 4 shows a perspective view of a modified order picked in accordance with the present invention;

FIG. 5 shows the order picker illustrated in FIG. 4 in conventional order picker mode;

FIG. 6 shows the order picker illustrated in FIG. 4 in conventional order picker raised mode;

FIG. 7 shows the order picker illustrated in FIG. 4 being used to access pallets stored above the level normally accessible to order picker in order picker mode;

FIG. 8 shows a perspective view illustrating a further modified order picker in accordance with the present invention;

FIG. 9a illustrates the manner in which the cab is secured to the outer section of the cab raise mast of the order picker illustrated in FIG. 8;

FIG. 9b illustrates the intermediate section of the cab raise mast of the order picker illustrated in FIG. 8;

FIG. 9c illustrates how the inner section of the cab raise mast of the order picker illustrated in FIG. 8 is secured to the body section;

FIG. 10 is a rear view of the cab raise mast of the order picker illustrated in FIG. 8;

FIG. 11 is a view of the of the cab raise mast of the order picker body illustrated in FIG. 8, from above; and

FIG. 12 is a detailed view of the intermediate section of the cab raise mast of the order picker body illustrated in FIG. 8.

### DETAILED DESCRIPTION OF THE PREFERRED EMBODIMENTS

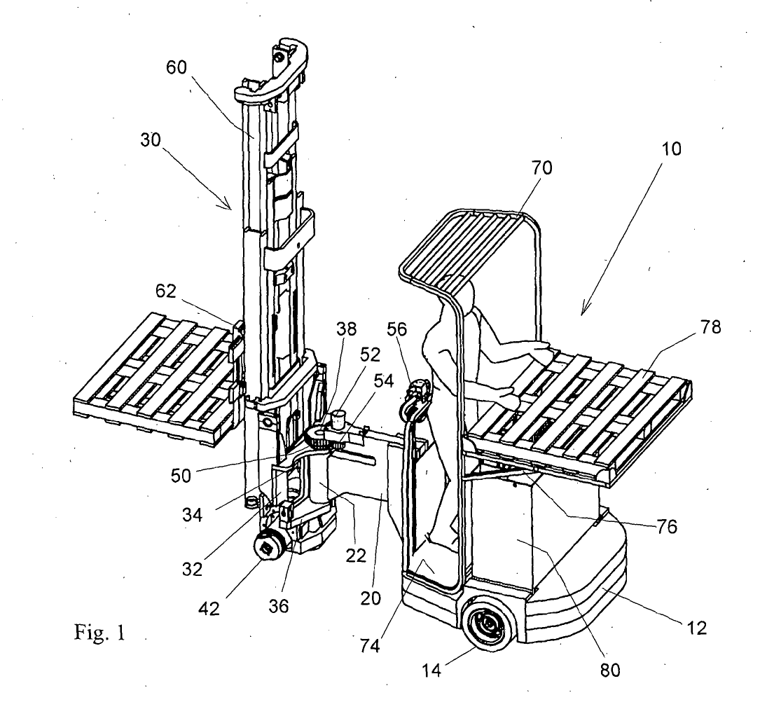

As illustrated in FIGS. 1 to 3 an order picker 10 has a body section 12 having a pair of rear ground engaging wheels 14, one wheel 14 being mounted on each side of the body section 12, towards the rear of the body section 12.

An arm 20 extends forwardly from the front of the body section 12, a vertical pivot tube 22 being provided at the end of the arm 20 remote from the body section 12.

A lift mechanism 30 has a yoke assembly 32 having an upper and lower plate members 34, 36 extending horizontally, a pivot pin 38 extending centrally between the plate members 34, 36, the pivot pin 38 being mounted in bearings, in the pivot tube 22.

A single ground engaging front wheel 40 is mounted on the yoke assembly 32, on an axle which is parallel to the plate members 34, 36. The front wheel is driven by an electric or hydraulic motor 42 and gear box 44 mounted coaxially of the wheel 40.

The pivot pin 38 is non-rotatably secured with respect to the yoke assembly 32. A gear 50 is secured to the pivot pin 38 or directly to the yoke assembly coaxially of the pivot pin 38 and is engaged by a gear 52 driven by an electric steering motor 54. A steering control on a control module 56 mounted in a fixed position on the front end of the body section 12, adjacent arm 20, is used to control the electric steering motor 54. The steering control may be used to energise the electric motor 54 in either direction, to pivot the yoke assembly 32 to one side or the other relative to the body section 12, and thereby steer to order picker 10. The yoke assembly 32 may be pivoted in excess of 90° to either side of the straight ahead position.

A telescopic lift mast 60 is mounted on the yoke assembly 32, a pair of forks 62 extending forwardly of the lift mast, being mounted on the lift mast for movement vertically thereof.

Means for controlling forward and reverse movement of the order picker 10 and for controlling movement of the telescopic mast 60 and forks 62, are also provided on the control module 56.

A cab 70 is mounted on the forward end of the body section 12, the cab 70 being mounted for vertical movement on a telescopic mast 72. The floor 74 of the cab 70 provides a platform upon which the operative may stand. The cab 70 is open to the front and provides access to the control module 56, when to cab 70 is in a lowered position. The cab 70 is open to each side to allow access to pallets or storage bins located in stacks on either side of the order picker 10. A frame structure 76 extends rearwardly from to rear of the cab 70, at a working height for supporting a pallet or other receptacle 78 onto which picked items may be placed.

Means for controlling telescopic mast 72 is mounted on the cab 70, for movement with the cab 70.

A battery pack 80 is provided to the rear of the body section 12, beneath the frame structure 76 on the cab 70, to power the various systems of the order picker. A motor and hydraulic pump (not shown) may also be provided on the body section 12, to power hydraulic systems of the order picker 10.

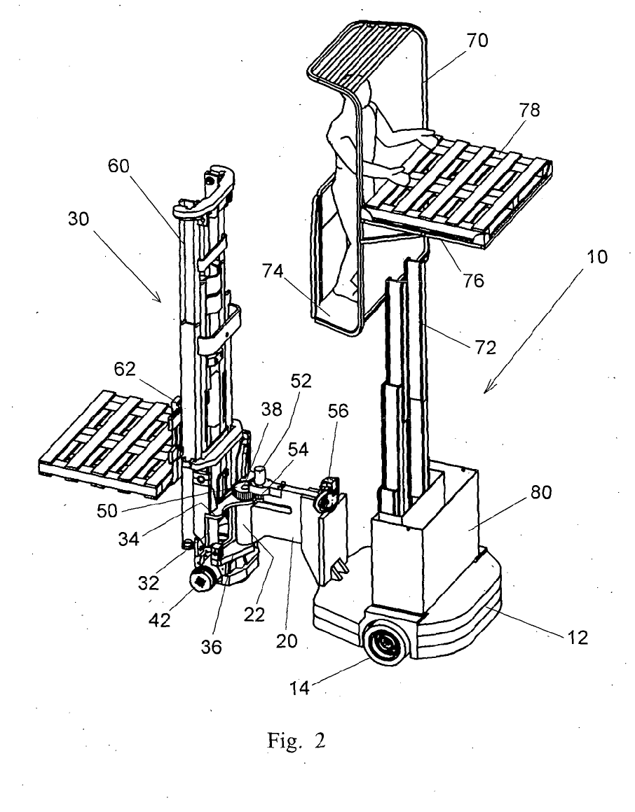

The order picker 10 described above may be used in conventional order picker mode to pick items from pallets or storage bins located in stacks on either side of an aisle as the order picker 10 is driven straight down the aisle. As illustrated in FIG. 2, the cab 70 may be raised, typically from 2.8 meters or higher, to pick items from storage pallets or bins on, for example, upto three or more levels. Picked items are placed by the operative on a pallet or other receptacle 78 supported on frame 76.

Alternatively, the order picker 10 may be used, with the cab 70 at its lowermost position, as a high reach lift truck, at heights typically from 7 meters to 12 meters. The articulation of the lift mechanism 30 providing good manoeuvrability and enabling the order picker 10 in this mode to operate in narrow aisles.

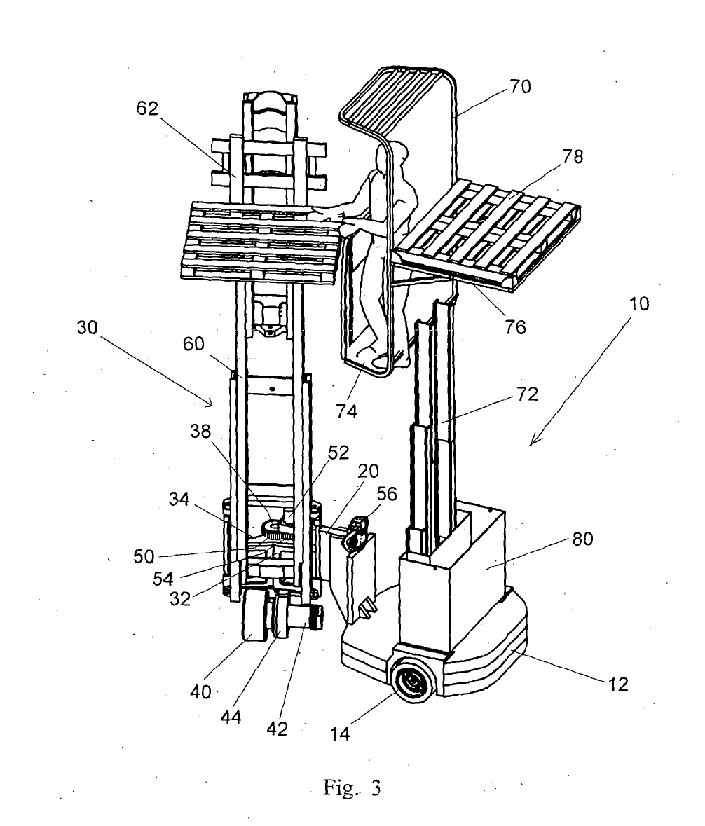

Furthermore, as illustrated in FIG. 3, the order picker 10 may be used in high reach mode to lower a storage pallet of bin to a level at which it is accessible from the cab 70 in a raised position, the cab 70 then being raised and the item picked from the storage pallet or bin supported in the lift mechanism 30.

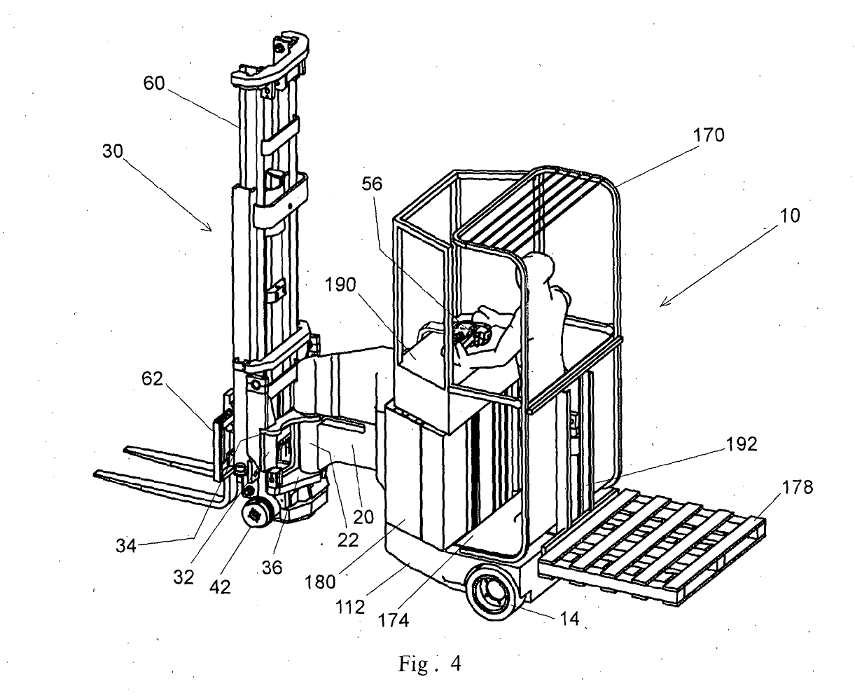

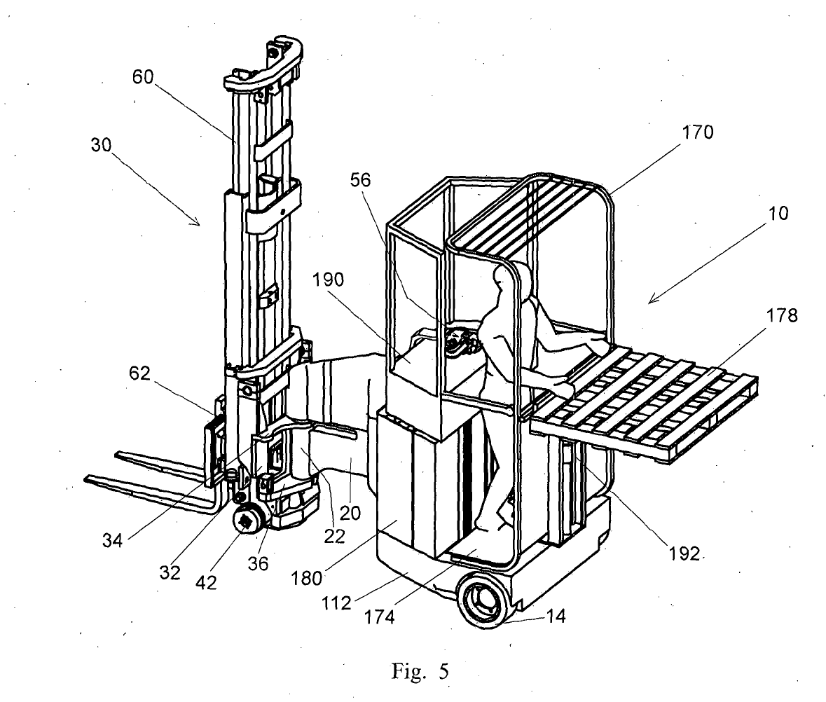

In the embodiment illustrated in FIGS. 4 to 6, the cab 170 is mounted on lift mast 172, towards the rear of the body section 112. The battery pack 180 is mounted towards the front of the body section 112.

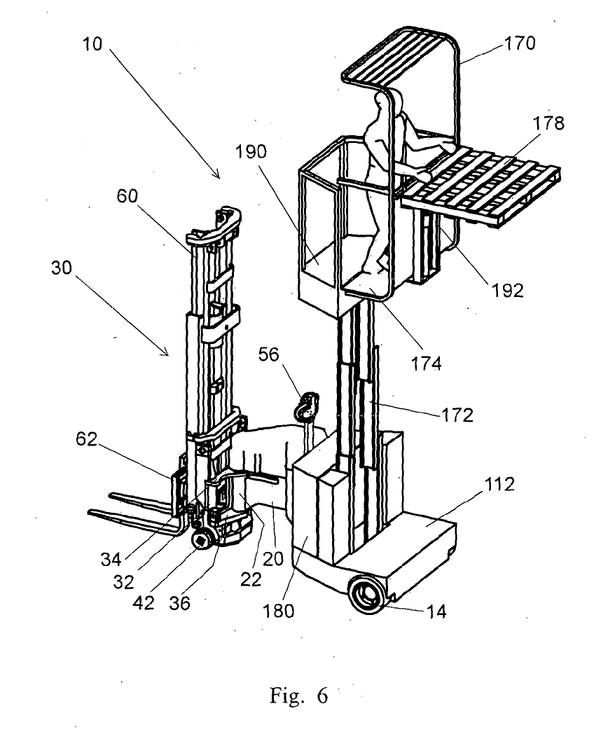

A floor extension 190 extends over the battery pack 180, the floor extension 190 being attached to the cab 170 for limited vertical movement relative there to, permitting the main floor 174 of the cab 170 to move below the floor extension 190 when it abuts the battery pack 180, the floor extension 190 being constrained to move with the cab 170 in alignment with the main floor 174, when the main floor 174 rises above the level of the battery pack 180. As illustrated in FIG. 6, the floor extension 190 will thereby permit access to storage pallets or bins supported on the lift mechanism 30, in similar manner to that described above with reference to FIG. 3, in spite of the increased distance between the cab 170 and lift mechanism 30.

In place of the fixed frame 76 of the embodiment illustrated in FIGS. 1 to 3, in the embodiment illustrated in FIGS. 4 to 6, the receptacle 178 is mounted on a pair of forks, the forks being mounted on the rear of the cab 170 on lift means 192. The receptacle 178, for example may thereby be lowered from its initial working height, as items are stacked on the receptacle 178, to maintain the working height. Moreover, the lift mechanism 192 may lower the forks and receptacle 178 to the ground, to unload the receptacle 178 from the order picker 10, when an order has been filled.

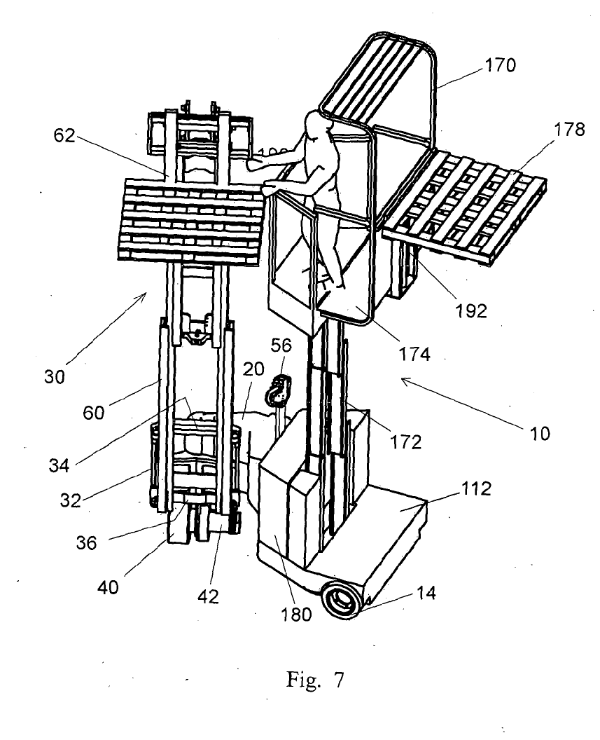

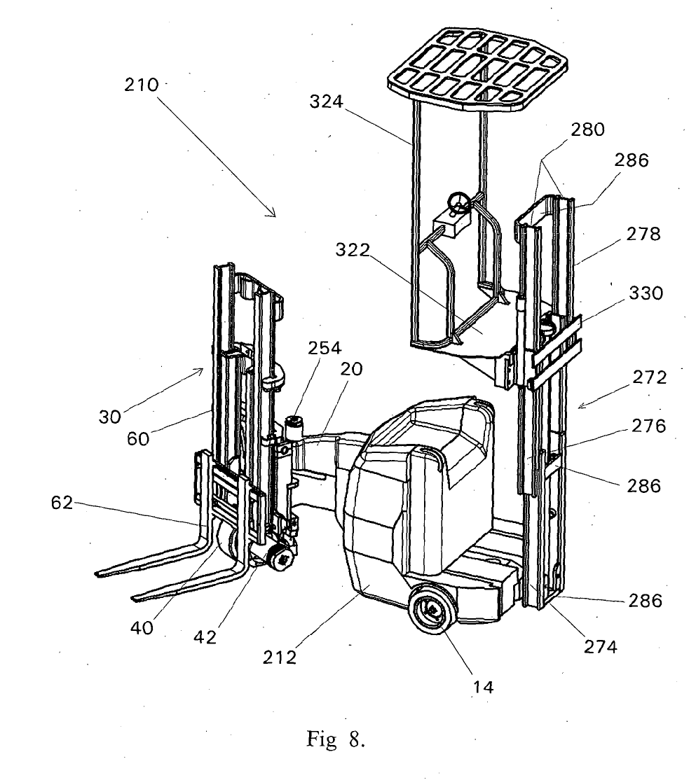

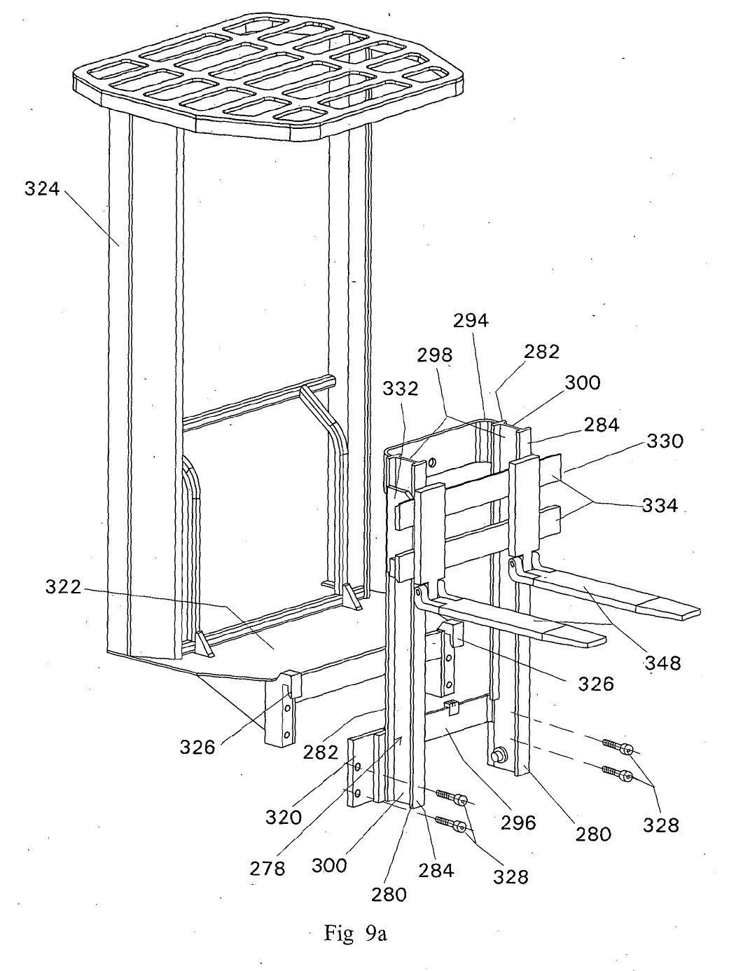

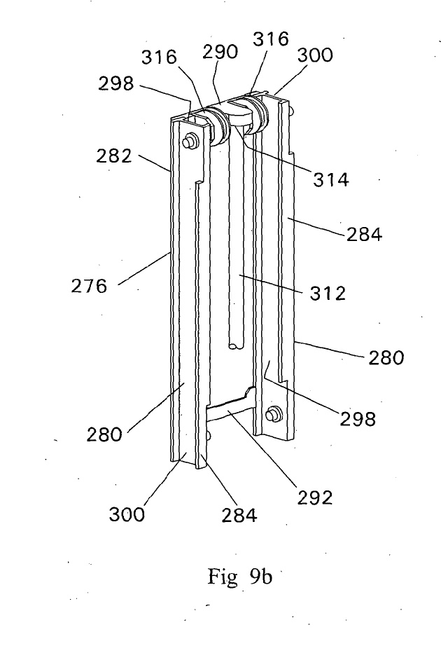

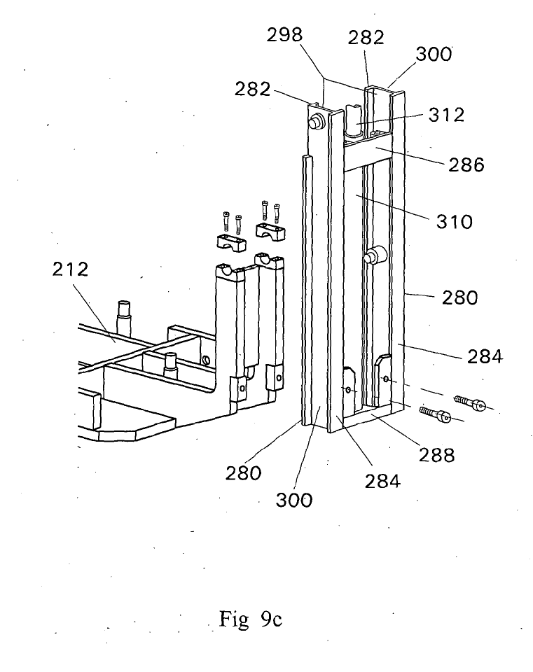

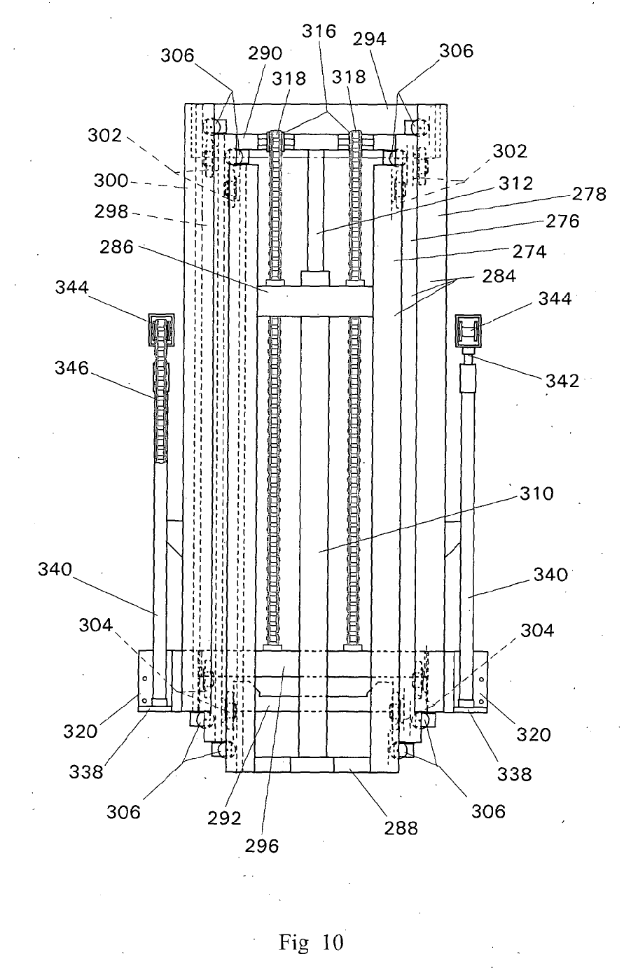

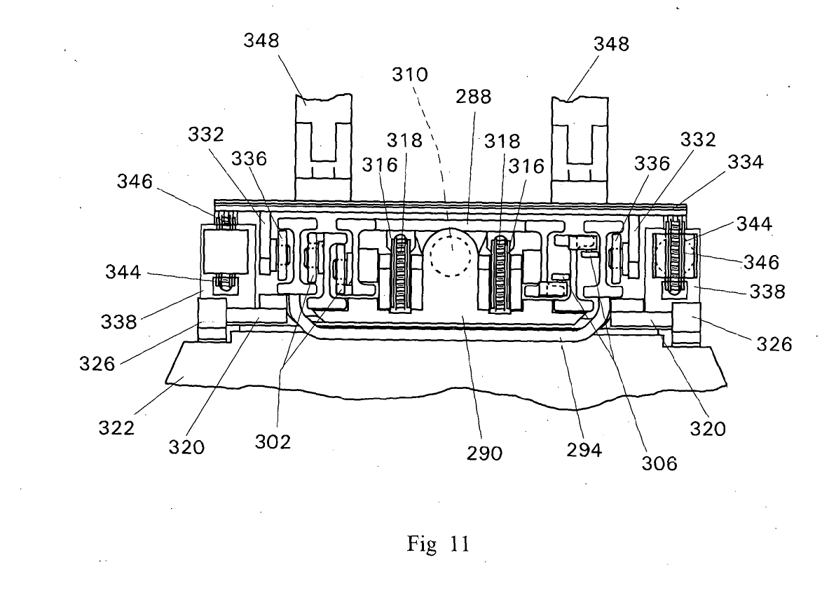

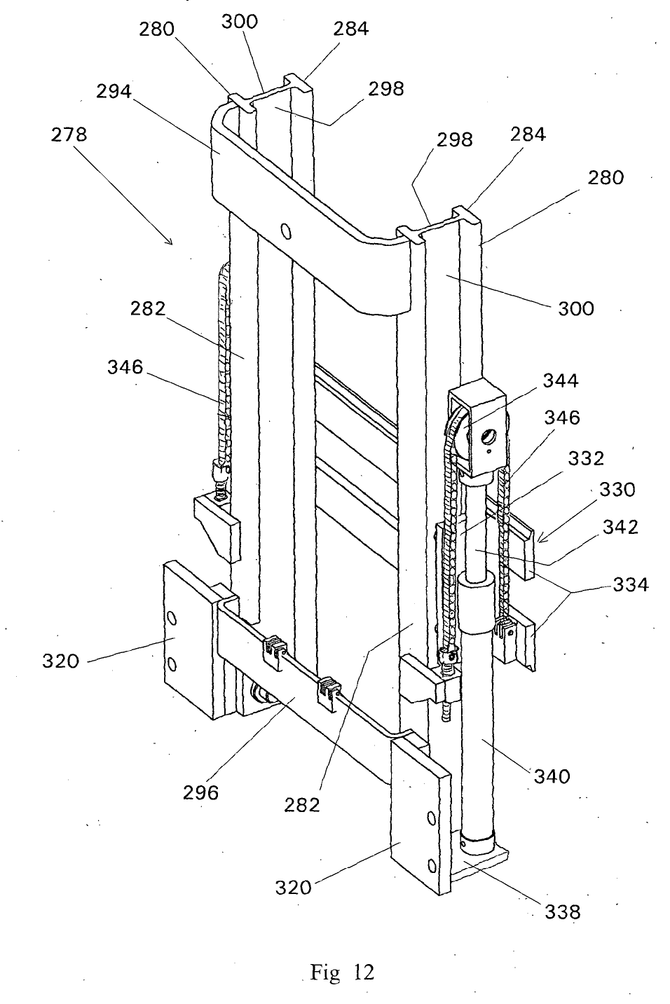

In the embodiment illustrated in FIGS. 8 to 12, the lift mechanism 30 is similar to that described with reference to FIGS. 1 to 7. In this embodiment a cab raise mast 272 is secured to the rear of the body section 212. The mast 272 comprises three sections, an inner section 274, an intermediate section 276 and an outer section 278. The sections 274, 276 and 278 of the mast are each formed from a pair of spaced apart I-section uprights 280 mounted parallel to one another with the front and rear flange formations 282, 284 of one upright of being coplanar of the corresponding front and rear flange formations 282, 284 of the other upright 280. The uprights 280 of each section 274, 276 and 278, are interconnected by upper and lower cross members 286, 288; 290, 292; and 294,296 respectively, located adjacent the top and bottom of the l-section uprights 280.

The cross members, 286, 288 of section 274; 290, 292 of section 276; and 294, 296 of section 278; vary in length so that the sections 274, 276 and 278 may be nested in telescopic manner. The uprights 280 of inner section 274 are located within the uprights 280 of intermediate section 276; with the outer portions of flange formations 282 of the inner section 274 engaging in the inner channel 298 formed between flange formations 282, 284 of intermediate section 276 and the inner portions of flange formations 284 of intermediate section 276 engaging in the outer channel 300 formed between flange formations 282, 284 of inner section 274. The uprights 280 of the intermediate section 276 are located within uprights 280 of the outer section 278, with the outer portions of flange formations 284 of intermediate section 276 engaging in the inner channel 298 formed between flange formations 282, 284 of outer section 278 and the inner portions of flange formations 282 of outer section 278 engaging in the outer channel 300 formed between flange formations 282, 284 of intermediate section 276.

Rollers 302 are attached adjacent the top of sections 274 and 276, the rollers 302 being rotatably attached in the outer channel sections 300 defined between flanges 282 and 284 of sections 274 and 276, for rotation about axes parallel to the plane the flange formations 282 and 284. The rollers 302 attached to inner section 274 extend into the inner channel sections 289 defined between the flange formations 282, 284 and engage the flange formations 284 of intermediate section 276. The rollers 302 attached to intermediate section 276 extend into the inner channel sections 289 defined between the flange formations 282, 284 of outer section 278 and engage the flange formations 282 of outer section 278.

Rollers 304 are pivotally attached adjacent the bottom of sections 276 and 278, the rollers 304 being pivotally attached in the inner channel sections 298 for rotation about axes parallel to the plane the flange formations 282 and 284. The rollers 304 on intermediate section 276 extend into the outer channel sections 300 defined between the flange formations 282, 284 and engage flange formations 282 on inner section 274. The rollers 304 on outer section 278 extend into the outer channel sections 300 defined between the flange formations 282, 284 and engage flange formations 284 on intermediate section 276.

The rollers 302 and 304 thereby ensure that as the sections 274, 276 and 278 move with respect to one another, the flange formations 282 and 284 of each section 274, 276, 278 are held in sliding engagement with the corresponding flange formations 282 and 284 of the adjacent section 274, 276, 278.

Cam rollers 306 are mounted to the top on both sides of the inner section 274 and intermediate section 276, on the outside of uprights 280; and on both sides to the bottom of intermediate section 276 and outer section 278 on the inside of uprights 280. The cam rollers 306 are mounted for rotation about axes perpendicular to the plane of the flange formations 282, 284. The cam rollers 306 at the top of inner section 274 run against the bases of the inner channels 298 of intermediate section 276, the cam rollers 306 at the bottom of intermediate section 276 run against the bases of the outer channel sections 300 of inner section 274. The cam rollers 306 at the top of intermediate section 276 run against the bases of the inner channels 298 of outer section 278, and the cam rollers 306 at the bottom of outer section 278 run against the bases of the outer channel sections 300 of intermediate section 276. The cam rollers 306 thereby serve to prevent lateral sway of the sections 276 and 278 of the mast 272.

The base of inner section 274 of the mast 272 is secured centrally to the rear of the body section 212.

A hydraulic ram 310 is secured to the lower and upper cross members 286, 288 of the inner section 274 of the mast 272, the ram 310 extending centrally of and parallel to the upright sections 280 of inner section 274. A piston 312 extends from the upper end of ram 310 and is secured at its free end 314 to the upper cross member 290 of the intermediate section 276. A pair of sprocket wheels 316 are mounted in cross member 290, one each side of the piston 312. The sprocket wheels 316 are mounted for rotation about an axis parallel to the plane of the flange formations 282, 284 of the inner section 274.

A pair of chains 318 engage the sprocket wheels 314, one end of each chain 318 being anchored to the upper cross member 286 of the inner section 274, while the other end of each chain 318 is anchored to the lower cross member 296 of the outer section 278. In this manner when the ram 310 is extended, intermediate section 276 will be lifted relative to inner section 274 by the piston 312, while the outer section 278 is raised relative to the intermediate section 276 by the chains 318.

A pair of plates 320 are secured to the front flange formations 282 of outer section 278, adjacent the bottom of section 278, the plates 320 extending outwardly of uprights 280. A platform 322 of a cab 324 is secured to the plates 320 by hook formations 326 and bolts 328, so that movement of outer section 278 by the ram 310 and chains 318, will raise and lower cab 324.

A carriage 330 comprises a pair of end plates 332 interconnected by upper and lower of cross members 334. The cross members 334 span outer section 278 of the mast 272, the end plates 332 extending in juxtaposed relationship to the outer sides of uprights 280 of outer section 278. A pair of vertically separated rollers 336 are pivotally attached to the inner surfaces of each of the end plates 332, the rollers extending into the outer channels 300 of outer section 278 and engaging the flange formations 282, 284.

A pair of hydraulic rams 340 are mounted, one on either side of outer section 278 of mast 272, outside the endplates of the carriage 330. The rams 340 are secured to extensions 338 of plates 320 and extend parallel to uprights 280 of outer section 278. Pistons 342 extend from the upper end of rams 340. A sprocket wheel 344 is secured to the free end of each piston 342, the sprocket wheels 344 being mounted for rotation about axes parallel to the plane of flange formations 282, 284. Chains 346 engage the sprocket wheels 344, one end of each chain being connected to the outer section 278 and the other end of each chains 346 being connected to the carriage 330. The rams 340 may thus be actuated to move the carriage 330 up and down the outer section 278 of the mast 272.

A pair of forks 348 are secured to the cross members 334 of carriage 330, to support a pallet or bin onto or into which picked items may be placed.

The cab 324 of this embodiment is provided with a suitably geared steering mechanism, for example a steering wheel 350 and drive controls which are mounted for movement up and down, with the cab 324. The steering mechanism 350 is connected electronically to the electric steering motor 254 which acts through a gear or corresponding mechanism 250, 252 to pivot the lift mechanism 30 and front wheel 40 relative to the body section 211, to steer the order picker. The order picker 210 may thereby be steered with the cab 212 raised of lowered.

Various modifications may be made without departing from the invention. For example while in the above embodiments a single front wheel 40 is provided on the lift mechanism 30, two front wheels may alternatively be provided. The or each front wheel and/or the rear wheels of the order picked may be driven.

The order picker may be driven, steered and the different lift mechanisms operated by means of electric motors or hydraulic mechanisms.

1-10. (canceled)

11. An order picker (10; 210) comprising:
a body section (12; 112; 212) having a pair of ground engaging wheels (14) and a first lift mechanism (30) pivotally mounted to one end of the body section (12; 112; 212) about a vertical pivot (38),
one or more ground engaging wheels (40) being provided on the first lift mechanism (30),
means (50, 52, 54) being provided for pivoting the first lift mechanism (30) relative to the body section (12; 112; 212) whereby the order picker (10; 210) may be steered,
an open cab (70; 170; 324) being provided on the body section (12; 112; 212) whereby an operative may have access to stacks on either side of the order picker (10; 210),
wherein the cab (70; 170; 324) being mounted to the body section (12; 112; 212) on a second lift mechanism (72; 172; 272) by which the cab (70; 170; 324) may be raised and lowered with respect to the body section (12; 112; 212) independently of the first lift mechanism (30); and
a receptacle (78; 178) onto or into which picked items may be placed, the receptacle (78; 178) being mounted on the cab (70: 170; 324) on the end thereof remote from the end of the body section (12; 112; 212) to which the first lift mechanism (30) is mounted.

12. The order picker (210) according to claim 11, wherein the second lift mechanism includes a cab raise lift mast (272) secured to the rear of the body section (212).

13. The order picker (210) according to claim 12, wherein the cab raise lift mast (272) of the second lift mechanism comprises a plurality of sections (274, 276,278), with one section being nested within another section in a telescopic manner.

14. The order picker according to claim 13, wherein the innermost section (274) of the cab raise lift mast (272) is secured to the body section (212).

15. The order picker (10; 210) according to claim 11, wherein the receptacle (178) is mounted to the cab (170; 324) by a third lift mechanism (192; 330,348) by which the receptacle (178) may be raised and lowered with respect to the cab (170; 324).

16. The order picker (210) according to claim 14, wherein the third lift mechanism (330, 348) raises and lowers the receptacle (178) on the outer section (278) of the cab raise lift mast (272).

17. The order picker (10; 210) according to claim 15, wherein the receptacle (178) is mounted on a pair of forks (348), and the forks (348) are mounted for vertical movement on the body section (112; 212).

18. The order picker (10; 210) according to claim 15, wherein the third lift mechanism (192; 330, 348) may be lowered to the ground, whereby a receptacle (178) may the picked up from the ground or deposited on the ground.

19. The order picker (10) according to claim 11, wherein when the cab (170) is in its lowermost position, the floor (174) of the cab (170) lies below a raised portion (180) of the body section (112), a floor extension (190) overlies the raised portion (180) of the body section (112), the floor extension (190) is attached to the cab (170) for limited vertical movement relative thereto, permitting the floor (174) of the cab (170) to move below the floor extension (190) when it abuts the raised portion (180) of the body section (112), the floor extension (190) is constrained to move with the cab (170) in alignment with the floor (174) of the cab (170), when the floor (174) of the cab (170) rises above the level of the raised portion (180) of the body section (112).

20. An order picker (10; 210) comprising:
a body section (12; 112; 212) having a pair of ground engaging wheels (14) and a first lift mechanism (30) pivotally mounted to one end of the body section (12; 112; 212) about a vertical pivot (38),
one or more ground engaging wheels (40) being provided on the first lift mechanism (30),
means (50, 52, 54) being provided for pivoting the first lift mechanism (30) relative to the body section (12; 112; 212) whereby the order picker (10; 210) may be steered,
an open cab (70; 170; 324) being provided on the body section (12; 112; 212) whereby an operative may have access to stacks on either side of the order picker (10; 210),
wherein the cab (70; 170; 324) being mounted to the body section (12; 112; 212) on a second lift mechanism (72; 172; 272) by which the cab (70; 170; 324) may be raised and lowered with respect to the body section (12; 112; 212) independently of the first lift mechanism (30);
a receptacle (78; 178) onto or into which picked items may be placed, the receptacle (78; 178) being mounted on the cab (70: 170; 324) on the end thereof remote from the end of the body section (12; 112; 212) to which the first lift mechanism (30) is mounted;
the second lift mechanism includes a cab raise lift mast (272) secured to the rear of the body section (212);
the cab raise lift mast (272) of the second lift mechanism comprises a plurality of sections (274, 276,278), with one section being nested within another section in a telescopic manner;
the innermost section (274) of the cab raise lift mast (272) is secured to the body section (212); and
the receptacle (178) is mounted to the cab (170; 324) by a third lift mechanism (192; 330,348) by which the receptacle (178) may be raised and lowered with respect to the cab (170; 324).

21. The order picker (210) according to claim 20, wherein the third lift mechanism (330, 348) raises and lowers the receptacle (178) on the outer section (278) of the cab raise lift mast (272).

22. The order picker (10; 210) according to claim 20, wherein the receptacle (178) is mounted on a pair of forks (348), and the forks (348) are mounted for vertical movement on the body section (112; 212).

23. The order picker (10; 210) according to claim 20, wherein the third lift mechanism (192; 330, 348) may be lowered to the ground, whereby a receptacle (178) may the picked up from the ground or deposited on the ground.

24. The order picker (10) according to claim 20, wherein when the cab (170) is in its lowermost position, the floor (174) of the cab (170) lies below a raised portion (180) of the body section (112), a floor extension (190) overlies the raised portion (180) of the body section (112), the floor extension (190) is attached to the cab (170) for limited vertical movement relative thereto, permitting the floor (174) of the cab (170) to move below the floor extension (190) when it abuts the raised portion (180) of the body section (112), the floor extension (190) is constrained to move with the cab (170) in alignment with the floor (174) of the cab (170), when the floor (174) of the cab (170) rises above the level of the raised portion (180) of the body section (112).
